(19) United States
(12) Patent Application Publication
(10) Pub. No.: US 2024/0254319 A1
(43) Pub. Date: Aug. 1, 2024

(54) VIBRATION-DAMPING RUBBER COMPOSITION AND VIBRATION-DAMPING RUBBER MEMBER

(71) Applicant: Sumitomo Riko Company Limited, Aichi (JP)

(72) Inventors: Yuto Watanabe, Aichi (JP); Seiji Kasai, Aichi (JP); Akio MASE, Aichi (JP); Yuko MATSUSHITA, Aichi (JP)

(73) Assignee: Sumitomo Riko Company Limited, Aichi (JP)

(21) Appl. No.: 18/629,913

(22) Filed: Apr. 8, 2024

Related U.S. Application Data
(63) Continuation of application No. PCT/JP2022/047884, filed on Dec. 26, 2022.

(30) Foreign Application Priority Data
Dec. 27, 2021 (JP) 2021-212743

(51) Int. Cl. C08K 13/02; C08K 3/36; C08K 5/47; C08K 5/5419; F16F 1/36

(52) U.S. Cl. CPC C08K 13/02; F16F 1/3605; C08K 3/36; C08K 5/47; C08K 5/5419; F16F 2224/025

(57) ABSTRACT

Provided are a vibration-damping rubber composition and a vibration-damping rubber member which have excellent durability, can attain a reduction in dynamic-to-static modulus ratio, and can exhibit excellent scorch resistance in wet-heat environments, etc. This vibration-damping rubber composition comprises a diene-based rubber composition including the following (A) to (C) and further containing the following (D) and (E), where the total amount of (D) and (E) is 1-5 parts by mass per 100 parts by mass of (A) and the mass ratio between (D) and (E) is (D):(E)=90:10 to 50:50: (A) a diene-based rubber; (B) silica; (C) a silane coupling agent; (D) N-oxydiethylene-2-benzothiazolylsulfenamide; and (E) Di-2-benzothiazolyl disulfide.

### CROSS-REFERENCE TO RELATED APPLICATION

This application is a continuation of PCT International Application No. PCT/JP2022/047884, filed on Dec. 26, 2022, which claims priority under 35 U.S.C § 119(a) to Japanese Patent Application No. 2021-212743, filed on Dec. 27, 2021. Each of the above application(s) is hereby expressly incorporated by reference, in its entirety, into the present application.

### BACKGROUND

### Technical Field

The disclosure relates to a vibration-damping rubber composition and a vibration-damping rubber member used for vibration damping in a vehicle, such as an automobile or a train.

### Description of Related Art

In the technical field of vibration-damping rubbers, high durability, reduced dynamic-to-static modulus ratio (reducing the dynamic-to-static modulus ratio [dynamic spring constant (Kd)/static spring constant (Ks)]), etc., are required. To meet such requirement, diene-based rubber, which is a polymer of a vibration-damping rubber composition, contains fillers such as carbon black and silica, Furthermore, a blending system in which a silane coupling agent is used alongside has been established (see, for example, Patent Documents 1 to 4) to improve the dispersibility of silica.

To further reduce the dynamic-to-static modulus ratio, the high dispersibility of silica, the crosslinked structure of the polymer rubber, and the bonding between the silica and the polymer rubber through a silane coupling agent are important.

### PRIOR ART DOCUMENT(S)

### Patent Document(s)

[Patent Document 1]: Japanese Patent No. 3838154
[Patent Document 2]: Japanese Laid-open No. 2017-8161
[Patent Document 3]: WO 2016/204012
[Patent Document 4]: Japanese Translation of PCT International Application Publication No. 2016-536415.

However, compared with the time when carbon black is blended as silica (filler), in the conventional vibration-damping rubber composition in which silica and silane coupling agent are blended as described above, an issue at the time of long-term storage, etc., may occur because the rubber composition may tend to scorch (rubber scorching) easily, particularly in a wet/hot environment (under a high-temperature and high-humidity condition).

The disclosure provides a vibration-damping rubber composition and a vibration-damping rubber member which have excellent durability, can attain a reduced dynamic-to-static modulus ratio, and can exhibit excellent scorch resistance in a wet/hot environment, etc.

### SUMMARY

An aspect of the disclosure provides vibration-damping rubber composition consisting of a diene-based rubber composition containing (A) to (C) as well as (D) and (E) as follows. A total content of (D) and (E) is 1 to 5 parts by mass per 100 parts by mass of (A), and a mass ratio between (D) and (E) is within (D):(E)=90:10 to 50:50, where: (A) is a diene-based rubber; (B) is silica; (C) is a silane coupling agent; (D) N-oxydiethylene-2-benzothiazolylsulfenamide; and (E) Di-2-benzothiazolyl disulfide.

### DESCRIPTION OF THE EMBODIMENTS

The inventors have conducted extensive research to address the above issue. During the research process, in order to increase durability and reduce the dynamic-to-static modulus ratio, a blend system in which silica and a silane coupling agent are used together is created for a diene-based rubber, which serves as the polymer of the vibration-damping rubber composition. In addition, repetitive investigations have been made by focusing on vulcanization accelerators to improve scorch resistance of such blend system.

For such blend system, N-cyclohexyl-2-benzothiazolylsulfenamide (CBS) is conventionally used as a vulcanization accelerator to be able to reduce the dynamic-to-static modulus ratio.

However, in the presence of silica that easily absorbs moisture, CBS may be hydrolyzed in a wet/hot environment to be transformed into 2-mercaptobenzothiazole (MBT) having higher vulcanization acceleration capability and, as a result, an effect of shortening scorch time is demonstrated.

Therefore, the inventors have selected, as vulcanization accelerators less likely to hydrolyze than CBS, N-oxydiethylene-2-benzothiazolylsulfenamide (MBS) and Di-2-benzothiazolyl disulfide (MBTS), and validated the effects of replacing CBS with these vulcanization accelerators. According to the results of validation, when MBS was used, the scorch time in a wet/hot environment can be made to the same level as when carbon black was blended, but in a dry/hot environment (under a high-temperature, low-moisture condition), there was a tendency for the scorch time to increase in the early stage over time. Therefore, it is learned that it would be difficult to handle in the actual process. Also, according to the results of validation, when MBTS was used, the scorch time in a wet/hot environment can be made to a level equal to or higher than when carbon black was blended. However, it is learned that dynamic properties deteriorated significantly.

However, when repeating the experiments, the inventors found that, by combining MBS and MBTS at a specific ratio, the respective strengths thereof can be brought out. In addition, according to such configuration, in a blend system using silica and a silane coupling agent together for a diene-based rubber, the reduced dynamic-to-static modulus ratio at a level same as when CBS was used can be achieved, and excellent scorch resistance (scorch time at a level same as when carbon black was blended), which cannot be obtained with combinations of CBS and conventional vulcanization accelerators, can be obtained.

That is, the gist of the present disclosure is [1] to [5] as follows.

[1] A vibration-damping rubber composition is provided. The vibration-damping rubber composition consists of a diene-based rubber composition containing (A) to (C) as well as (D) and (E) as follows.

A total content of (D) and (E) is 1 to 5 parts by mass per 100 parts by mass of (A).

A mass ratio between (D) and (E) is within (D):(E)=90:10 to 50:50, where:
(A) is a diene-based rubber;
(B) is silica;
(C) is a silane coupling agent;
(D) N-oxydiethylene-2-benzothiazolylsulfenamide; and
(E) Di-2-benzothiazolyl disulfide.

[2] In the vibration-damping rubber composition of [1], a content of (B) is 5 to 100 parts by mass per 100 parts by mass of (A).

[3] In the vibration-damping rubber composition of [1] or [2], a content of (C) is 2 to 12 parts by mass per 100 parts by mass of (A).

In the vibration-damping rubber composition of any one of [1] to [3], (C) is at least one selected from a group consisting of a mercapto-based silane coupling agent and a sulfide-based silane coupling agent.

[5] A vibration-damping rubber member is provided. The vibration-damping rubber member consists of a vulcanized body of the vibration-damping rubber composition according to any one of [1] to [4].

In this way, the vibration-damping rubber composition according to the disclosure contains a polymer consisting of the diene-based rubber (A), the silica (B), and the silane coupling agent (C), and further contains N-oxydiethylene-2-benzothiazolylsulfenamide (D) and (E) Di-2-benzothiazolyl disulfide at specific proportions. Therefore, the vibration-damping rubber composition according to the disclosure can demonstrate excellent scorch resistance while achieving high durability and reduced dynamic-to-static modulus ratio.

In the following, the embodiments of the disclosure will be described in detail. However, the disclosure is not limited to such embodiments.

It is noted that, in the disclosure, when expressed as “X to Y” (X and Y being arbitrary numerical values), such expression covers the meaning “X or more and Y or less”, as well as the meanings “preferably greater than X” or “preferably less than Y”, unless otherwise specified.

Also, when expressed as “X or more” (X being an arbitrary numerical value) or “Y or less” (Y being an arbitrary numerical value), the meaning indicating “being greater than X is preferred” or “being less than Y is preferred” is also covered.

A vibration-damping rubber composition according to an embodiment of the disclosure (referred to as “the vibration-damping rubber composition”), as mentioned above, consists of a diene-based rubber composition containing (A) to (C) as follows and contains (D) and (E) as follows. A total amount of (D) and (E) is 1 to 5 parts by mass per 100 parts by mass of (A), and a mass ratio between (D) and (E) falls within (D):(E)=90:10 to 50:50. In addition,
(A) is a diene-based rubber;
(B) is silica;
(C) is a silane coupling agent;
(D) is N-oxydiethylene-2-benzothiazolylsulfenamide (MBS); and
(E) is Di-2-benzothiazolyl disulfide (MBTS).

As described above, the vibration-damping rubber composition is a diene-based rubber composition, so the diene-based rubber (A) is used in the polymer. As described above, since the vibration-damping rubber composition is a diene-based rubber composition, it is preferred that no other polymer is used except for the diene-based rubber (A) in the vibration-damping rubber composition. However, it is possible to use a polymer other than the diene-based rubber (A) within a certain amount (e.g., less than 30% by mass of the total of the polymer).

In the following, materials forming the vibration-damping rubber composition will be described in detail.

### [Diene-Based Rubber (A)]

As the diene-based rubber (A) used in the vibration-damping rubber composition, a diene-based rubber with natural rubber (NR) as the main component is preferably used. Here, “main component” refers to the diene-based rubber (A) in which 50% by mass or more is natural rubber, preferably refers to the diene-based rubber (A) in which 80% by mass or more is natural rubber, more preferably refers to the diene-based rubber (A) in which 90% by mass or more is natural rubber, and one that the diene-based rubber (A) only consists of natural rubber is also included. In this way, with natural rubber as the main component, the strength and the reduced dynamic-to-static modulus ratio become superior.

In addition, examples of diene-based rubbers other than natural rubber include butadiene rubber (BR), styrene-butadiene rubber (SBR), chloroprene rubber (CR), isoprene rubber (IR), acrylonitrile-butadiene rubber (NBR), ethylene-propylene-diene rubber (EPDM), butyl rubber (IIR), etc. These materials may be used alone or two or more thereof may be used together. It is noted that, these diene-based rubbers are preferably used together with natural rubber.

### [Silica (B)]

As the silica (B) used in the vibration-damping rubber composition, for example, wet silica, dry silica, colloidal silica, etc. are used. In addition, these materials may be used alone or two or more thereof may be used together.

In addition, from the perspective of achieving both high durability and reduced dynamic-to-static modulus ratio, the BET specific surface area of the silica (B) is preferably 20 m²/g to 380 m²/g.

The BET specific surface area of the silica (B), for example, can be measured by degassing a test material at 200° C. for 15 minutes and then using a mixed gas (N²: 70%, He: 30%) as an absorption gas by using a BET specific surface area measurement device (4232-II manufactured by Microdata).

From the perspectives of achieving high durability and reduced dynamic-to-static modulus ratio, the content of the silica (B) is preferably 5 to 100 parts by mass per 100 parts by mass of the diene-based rubber (A), and, from the same perspective, the content of the silica (B) is more preferably 10 to 80 parts by mass, and even more preferably 15 to 75 parts by mass, per 100 parts by mass of the diene-based rubber (A).

### [Silane Coupling Agent (C)]

In addition, as the silane coupling agent (C) used in the vibration-damping rubber composition, for example, one alone or a combination of two or more of a mercapto-based silane coupling agent, a sulfide-based silane coupling agent, an amine-based silane coupling agent, an epoxy-based silane coupling agent, a vinyl-based silane coupling agent, etc., is used. Among these materials, the silane coupling agent (C) is preferably a mercapto-based silane coupling agent or a sulfide-based silane coupling agent because the vulcaniation density is increased, the dynamic-to-static modulus ratio is low, and the durability is excellent.

As the mercapto-based silane coupling agent, examples include 3-mercaptopropyltrimethoxysilane, 3-mercaptopropyltriethoxysilane, etc. These materials may be used alone or two or more thereof may be used together.

As the sulfide-based silane coupling agent, examples include bis-(3-(triethoxysilyl)-propyl)-disulfide, bis(3-tricthoxysilylpropyl) trisulfide, bis-(3-(triethoxysilyl)-propyl)-tetrasulfide, bis(3-trimethoxysilylpropyl) disulfide, bis(2-triethoxysilylethyl)tetrasulfide, bis(2-trimethoxysilylethyl)tetrasulfide, bis(3-triethoxysilylpropyl) disulfide, 3-trimethoxysilylpropyl-N,N-dimethylthiocarbamoyltetrasulfide, 3-triethoxysilylpropyl-N,N-dimethylthiocarbamoyltetrasulfide, 2-triethoxysilylethyl-N,N-dimethylthiocarbamoyltetrasulfide, 2-trimethoxysilylethyl-N,N-dimethylthiocarbamoyltetrasulfide, 3-trimethoxysilylpropylbenzothiazolyl tetrasulfide, 3-triethoxysilylpropylbenzothiazole tetrasulfide, 3-triethoxysilylpropyl methacrylate monosulfide, 3-trimethoxysilylpropyl methacrylate monosulfide, etc. These materials may be used alone or two or more thereof may be used together.

As the amine-based silane coupling agent, examples include 3-aminopropyltriethoxysilane, 3-aminopropyltrimethoxysilane, N-(2-aminoethyl)-3-aminopropyltrimethoxysilane, N-(2-aminoethyl)-3-aminopropylmethyldimethoxysilane, 3-(N-phenyl) aminopropyltrimethoxysilane, etc. These materials may be used alone or two or more thereof may be used together.

As the epoxy-based silane coupling agent, examples include 2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxysilane, 3-glycidoxypropylmethyldimethoxysilane, etc. These materials may be used alone or two or more thereof may be used together.

As the vinyl-based silane coupling agent, examples include vinyltriethoxysilane, vinyltrimethoxysilane, vinyl tris (β-methoxyethoxy)silane, vinyldimethylchlorosilane, vinyltrichlorosilane, vinyltriisopropoxysilane, vinyl tris(2-methoxyethoxy)silane, etc. These materials may be used alone or two or more thereof may be used together.

From the perspective of achieving high durability and reduced dynamic-to-static modulus ratio, the content of the silane coupling agent (C) is preferably within the range of 2 to 12 parts by mass, and more preferably within the range of 3 to 10 parts by mass, per 100 parts by mass of the diene-based rubber (A).

### [Vulcanization Accelerators (D), (E)]

In addition, as the vulcanization accelerators used in the vibration-damping rubber composition, specific vulcanization accelerators, i.e., N-oxydiethylene-2-benzothiazolylsulfenamide (MBS) indicated in (D) and Di-2-benzothiazolyl disulfide (MBTS) indicated in (E), are used together.

In addition, in the vibration-damping rubber composition, the total content of MBS (D) and MBTS (E) is within the range of 1 to 5 parts by mass, preferably within the range of 1.5 to 5 parts by mass, and more preferably within the range of 2 to 5 parts by mass, per 100 parts by mass of the diene-based rubber (A).

In addition, in the vibration-damping rubber composition, the mass ratio between the MBS (D) and the MBTS (E) is a mass ratio of (D):(E)=90:10 to 50:50, preferably (D):(E)=85:15 to 55:45. By using the MBS (D) and the MBTS (E) at such mass ratio, excellent scorch resistance that cannot be obtained with combinations of conventional vulcanization accelerators can be achieved, while a reduced dynamic-to-static modulus ratio, etc., is achieved in the vibration-damping rubber composition.

The vibration-damping rubber composition may properly contain, as needed, a vulcanization agent, a vulcanization aid, an anti-aging agent, a process oil, carbon black, etc., together with (A) to (E) as the necessary components.

As the vulcanization agent, examples include sulfur (powdered sulfur, precipitated sulfur, insoluble sulfur), sulfur-containing compounds such as alkylphenol disulfides, etc. These materials may be used alone or two or more thereof may be used together.

The content of the vulcanization agent is preferably within the range of 0.1 to 10 parts by mass, and particularly preferably within the range of 0.3 to 5 parts by mass, per 100 parts by mass of the diene-based rubber (A). This is because when the content of the vulcanization agent is too little, the vulcanization reactivity tends to deteriorate, and when the content of the vulcanization agent is too much, rubber physical properties (breaking strength, breaking elongation) tend to decrease.

As the vulcanization aid, examples include zinc oxide (ZnO), stearic acid, magnesium oxide, etc. These materials may be used alone or two or more thereof may be used together.

In the case where the vulcanization aid is used, the content thereof is preferably within the range of 0.1 to 10 parts by mass, and particularly preferably within the range of 0.3 to 7 parts by mass, per 100 parts by mass of the diene-based rubber (A).

As the anti-aging agent, examples include a carbamate-based anti-aging agent, a phenylene diamine-based anti-aging agent, a phenol-based anti-aging agent, a diphenylamine-based anti-aging agent, a quinoline-based anti-aging agent, an imidazole-based anti-aging agent, wax, etc. These materials may be used alone or two or more thereof may be used together.

In the case where the anti-aging agent is used, the content thereof is preferably within the range of 0.5 to 15 parts by mass, and particularly preferably within the range of 1 to 10 parts by mass, per 100 parts by mass of the diene-based rubber (A).

As the process oil, examples include naphthenic oil, paraffinic oil, and aromatic oil, etc. These materials may be used alone or two or more thereof may be used together.

In the case where the process oil is used, the content thereof is preferably within the range of 1 to 35 parts by mass, and particularly preferably within the range of 3 to 30 parts by mass, per 100 parts by mass of the diene-based rubber (A).

In addition, in the vibration-damping rubber composition, carbon black may also be contained as needed within a range that does not affect the reduced dynamic-to-static modulus ratio, etc., due to the silica (B) and the silane coupling agent (C).

The carbon black preferably has a BET specific surface area of 10 to 150 m²/g, and more preferably has a BET specific surface area of 65 to 85 m²/g.

The BET specific surface area of the carbon black, for example, can be measured by degassing a test material at 200° C. for 15 minutes and then using a mixed gas (N²: 70%, He: 30%) as absorption gas and measuring by using a BET specific surface area measurement device (4232-II manufactured by Microdata).

Regarding the grade of carbon black, from the perspective of reinforcement and durability, various grades of carbon black are used, such as FEF class, MAF class, GPF class, SRF class, FT class, and MT class. These materials may be used alone or two or more thereof may be used together. Among these, from the perspective, carbon black of FEF class is preferably used.

In the case where the carbon black is used, from the perspective of fatigue resistance, the content thereof is preferably within the range of 0.1 to 5 parts by mass, and particularly preferably within the range of 0.1 to 3 parts by mass, per 100 parts by mass of the diene-based rubber (A).

### [Method for Preparing Vibration-Damping Rubber Composition]

Here, the vibration-damping rubber composition can be prepared by using (A) to (E) as necessary components at specific proportions, and, as needed, using other materials as listed above, and kneading these materials by using a kneading machine, such as a kneader, a Banbury mixer, an open roll, and a two-axis screw stirrer, etc.

In particular, it is preferred that the kneading is performed by kneading materials except for the vulcanization agent and the vulcanization accelerator by using a Banbury mixer at 100° C. to 170° C. for 3 to 10 minutes (preferably kneading at 150° C. to 160° C. for 3 to 5 minutes), then blending the vulcanization agent and the vulcanization accelerator, and kneading by using an open roll at 30° C. to 80° C. for 3 to 10 minutes (preferably kneading at 30° C. to 60° C. for 3 to 5 minutes). The vibration-damping rubber composition so obtained can have excellent durability and reduced dynamic-to-static modulus ratio, and can exhibit excellent scorch resistance in a wet/hot environment, etc.

In addition, by vulcanizing at a high temperature (150° C. to 170° C.) for 5 to 30 minutes, the vibration-damping rubber composition becomes a vibration-damping rubber member (a vulcanized body).

The vibration-damping rubber member consisting of the vulcanized body of the vibration-damping rubber composition is preferably used as a formation member of an engine mount, a stabilizer bush, a suspension bush, a motor mount, sub-frame mount, etc., used in a vehicle, etc., such as an automobile.

Also, in addition to the above uses, the vibration-damping rubber composition can also be used for the purpose of a vibration-damping (vibration control) device and a base isolation device, such as a vibration damper for a computer hard disk, a vibration damper for general home appliances such as a washing machine, an architectural vibration-damping wall for a building and housing, and a vibration-damping (vibration control) damper, etc.

### EXAMPLES

In the following, examples are described together with comparative examples. However, the disclosure is not limited to the examples.

### Examples 1 to 5, Comparative Examples 1 to 6

100 parts by mass of natural rubber, 50 parts by mass of silica (Ultrasil VN-3 manufactured by DEGUSSA with a BET specific surface area of 200 m²/g (value measured according to the above method)), 7 parts by mass of the silane coupling agent (NXT manufactured by Momentive), 5 parts by mass of zinc oxide (Zinc Oxide Type 2 manufactured by Sakai Chemical Industry Co., Ltd.), 2 parts by mass of stearic acid (Beads Stearic Acid Sakura manufactured by NOF Corporation), 1 part by mass of the anti-aging agent (Antigen 6C manufactured by Sumitomo Chemical Co., Ltd.), and 3 parts by mass of the process oil (Sansen 410 manufactured by Nippon Sun Oil Co., Ltd.) were kneaded by using a Banbury mixer at 150° C. for 5 minutes.

The vulcanization agents (CBS, MBS, MBTS) as indicated in Table 1 in the following were blended with the kneaded matter so obtained at proportions indicated in the same table, Then, 2.5 parts by mass of the vulcanization agent (sulfur, manufactured by Karuizawa Smelter Co., Ltd.) were added, and the matter was kneaded by using an open roll at 60° C. for 5 minutes. Accordingly, the vibration-damping rubber compositions were prepared.

For CBS, (N-cyclohexyl-2-benzothiazolylsulfenamide), ACCEL CZ manufactured by Kawaguchi Chemical Co., Ltd. was used. For MBS, ACCEL NS manufactured by Kawaguchi Chemical Co., Ltd. was used. For MBTS, ACCEL DM manufactured by Kawaguchi Chemical Co., Ltd. was used.

The vibration-damping rubber compositions of the examples and the comparative examples obtained in this way were used, and the respective properties were evaluated according to the following criteria. The results are also shown in Table 1 in the following.

### <Scorch Resistance>

The respective vibration-damping rubber compositions were stored in an environment of 40° C., 20% RH (dry/hot environment) or an environment of 40° C., 95% RH (wet/hot environment) for predetermined numbers of days (4 days, 7 days, 14 days). In addition, values of scorch time (ST) at the test temperature (121° C.) for the respective vibration-damping rubber compositions on the 0^{th} day of storage and the respective vibration-damping rubber compositions after being stored for predetermined numbers of days were measured by using a Mooney viscometer manufactured by Toyo Seiki Co., Ltd.

In Table 1 in the following, for the respective vibration-damping rubber compositions, the ST values after storage for the predetermined numbers of days are expressed as index values with the ST value on the 0^{th} day of storage being taken as 100 (reference).

In addition, regarding the matters stored in the environment of 40° C., 20% RH, a matter whose values obtained by converting into index values from the values of ST were all higher than Comparative Example 1 in the respective numbers of days of storage and whose value of the 4^{th} day of storage obtained by converting into an index value from the value of ST is within 100±5 is considered as “◯ (very good)”, indicating excellent scorch resistance, and a matter not satisfying such condition of “◯ (very good)” is considered as “x (poor)”, indicating poor scorch resistance.

In addition, regarding the matters stored in the environment of 40° C., 95% RH, a matter whose the values obtained by converting into index values from the values of ST were all higher than Comparative Example 1 in the respective numbers of days of storage is considered as “◯ (very good)”, indicating excellent scorch resistance, and a matter not satisfying such condition of “◯ (very good)” is considered as “x (poor)”, indicating poor scorch resistance.

The reason why the condition “a matter whose value of the 4^{th} day of storage obtained by converting into an index value the value of ST is within 100±5” is added as a criterion for evaluating the scorch resistance for matters stored in the environment of 40° C., 20% RH in addition to whether such matter has superiority with respect to Comparative Example 1 (using CBS as the vulcanization agent) is to see if it is possible to indicate the optimal vulcanization time after storage under a storage condition assumed to be the normal manufacturing environment (4 days of storage at 40° C. and 20% RH).

### <Dynamic-to-Static Modulus Ratio>

Each vibration-damping rubber composition was press-molded (vulcanized) at 150° C. for 30 minutes to manufacture a test piece. In addition, a static spring constant (Ks) and a dynamic spring constant (Kd100) at a frequency of 100 Hz of the test piece were each measured according to JIS K 6386. Based on the value, the dynamic-to-static modulus ratio (Kd100/Ks) was calculated.

In Table 1 in the following, the values obtained by converting the measurement values of the dynamic-to-static modulus ratio into index values for the respective examples and comparative examples when the dynamic-to-static modulus ratio (Kd100/Ks) of Comparative Example 1 is considered as 100 are shown.

In addition, a matter whose value of the dynamic-to-static modulus ratio is within 100±5% of the value of the dynamic-to-static modulus ratio of Comparative Example 1 is considered as “◯ (very good)”, and a matter whose value is not within 100±5% of the value of the dynamic-to-static modulus ratio of Comparative Example 1 is considered as “x (poor)”.

The reason of setting such criterion is to see whether the reduction of the dynamic-to-static modulus ratio is at a level same as Comparative Example 1 (using CBS as the vulcanization agent).

TABLE 1

| | | Comparative Example | | | Example | | | | | Comparative Example | | |
|---|---|---|---|---|---|---|---|---|---|---|---|---|
| | | 1 | 2 | 3 | 1 | 2 | 3 | 4 | 5 | 4 | 5 | 6 |
| Vulcanization | MBS | — | 3.50 | [symbol] | 3.15 | 2.80 | 2.63 | 2.45 | 2.10 | — | 0.88 | — |
| Accelerator | MBTS | — | — | 0.26 | 0.53 | 1.05 | 1.31 | [symbol] | 2.10 | 2.63 | [symbol] | 5.25 |
| [parts by mass] | CBS | 3.50 | — | — | — | — | — | — | — | — | — | — |
| MBS:MBTS | [mass ratio] | — | 100:0 | [symbol] | [symbol] | [symbol] | [symbol] | [symbol] | [symbol] | [symbol] | [symbol] | [symbol] |
| Scorck Resistance | Day [symbol] | 100 | 100 | 100 | [symbol] | 100 | 100 | 100 | 100 | 100 | 100 | 100 |
| (40° C., 20% RH) | Day 4 | [symbol] | 114 | 113 | [symbol] | [symbol] | 101 | 101 | 98 | [symbol] | 105 | 109 |
| ST [Index] | Day 7 | 63 | [symbol] | [symbol] | [symbol] | [symbol] | [symbol] | 84 | [symbol] | [symbol] | 105 | 112 |
| | Day 14 | [symbol] | [symbol] | 86 | [symbol] | 81 | 81 | 82 | 76 | [symbol] | 105 | 114 |
| | Evaluation | — | x | x | ∘ | ∘ | ∘ | ∘ | ∘ | ∘ | ∘ | x |
| Scorck Resistance | Day [symbol] | 100 | 100 | 100 | 100 | 100 | 100 | 100 | 100 | 100 | 100 | 100 |
| (40° C., 95% RH) | Day 4 | [symbol] | [symbol] | 72 | [symbol] | [symbol] | 65 | 70 | [symbol] | [symbol] | [symbol] | 81 |
| ST [Index] | Day 7 | 46 | 63 | [symbol] | [symbol] | [symbol] | 61 | [symbol] | [symbol] | [symbol] | [symbol] | 72 |
| | Day 14 | [symbol] | 44 | [symbol] | 47 | 56 | 49 | 53 | 50 | 53 | 55 | [symbol] |
| | Evaluation | — | ∘ | ∘ | ∘ | ∘ | ∘ | ∘ | ∘ | ∘ | ∘ | ∘ |
| Dynamic-to-static | [Index] | 100 | [symbol] | [symbol] | 100 | 100 | [symbol] | 100 | 104 | [symbol] | 111 | 114 |
| Modulus Ratio | Evaluation | — | ∘ | ∘ | ∘ | ∘ | ∘ | ∘ | ∘ | x | x | x |

[symbol]

indicates data missing or illegible when filed

According to the results of Table 1, the vibration-damping rubber compositions of the examples, whose total contents of MBS and MBTS fall within the range defined in the disclosure and whose mass ratios between MBS and MBTS fall within the range defined in the disclosure, exhibit the level of reduction of the dynamic-to-static modulus ratio same as Comparative Example 1 (using CBS as the vulcanization agent) and are recognized to exhibit superiority difference in scorch resistance with respect to the rubber composition of Comparative Example 1. In addition, for the vibration-damping rubber compositions of the examples, the evaluation on scorch resistance is recognized to be advantageous in terms of being able to indicate the optimal vulcanization time after storage (storage for four days in the environment of 40° C. and 20% RH) under the storage condition assumed to be the normal manufacturing condition.

Comparatively, although the vibration-damping rubber compositions of Comparative Examples 2 to 6 use MBS and MBTS as vulcanization agents, these compositions do not satisfy the requirement of the disclosure on the proportion of the vulcanization agent, etc. As a result, the scorch resistance and the reduced dynamic-to-static modulus ratio as required in the disclosure are not achieved at the same time. Although the vibration-damping rubber composition of Comparative Examples 2, 3, and 6 are recognized to exhibit superiority difference in scorch resistance with respect to the rubber composition of Comparative Example 1, as described above, these compositions cannot indicate the optimal vulcanization time when being stored under the storage condition assumed to be the normal manufacturing condition, and is therefore considered as “x (poor)” in terms of scorch resistance in the environment of 40° C. and 20% RH.

In the above embodiments, specific embodiments of the disclosure have been shown, but the above embodiments are merely illustrative and should not be construed as limiting. Various modifications apparent to those skilled in the art are intended to be within the scope of the disclosure.

The vibration-damping rubber composition of the disclosure is preferably used as the material of a formation member (vibration-damping rubber member) of an engine mount, a stabilizer bush, a suspension bush, a motor mount, sub-frame mount, etc., used in a vehicle, etc., such as an automobile. However, in addition to the above, the vibration-damping rubber composition can also be used as the material of a formation member (vibration-damping rubber member) of a vibration-damping (vibration control) device and a base isolation device, such as a vibration damper for a computer hard disk, a vibration damper for general home appliances such as a washing machine, an architectural vibration-damping wall for a building and housing, and a vibration-damping (vibration control) damper, etc.

What is claimed is:

1. A vibration-damping rubber composition, consisting of a diene-based rubber composition containing (A) to (C) as well as (D) and (E) as follows,
wherein a total content of (D) and (E) is 1 to 5 parts by mass per 100 parts by mass of (A), and
a mass ratio between (D) and (E) is within (D):(E)=90:10 to 50:50, wherein:
(A) is a diene-based rubber;
(B) is silica;
(C) is a silane coupling agent;
(D) N-oxydiethylene-2-benzothiazolylsulfenamide; and
(E) Di-2-benzothiazolyl disulfide.

2. The vibration-damping rubber composition as claimed in claim 1, wherein a content of (B) is 5 to 100 parts by mass per 100 parts by mass of (A).

3. The vibration-damping rubber composition as claimed in claim 1, wherein a content of (C) is 2 to 12 parts by mass per 100 parts by mass of (A).

4. The vibration-damping rubber composition as claimed in claim 2, wherein a content of (C) is 2 to 12 parts by mass per 100 parts by mass of (A).

5. The vibration-damping rubber composition as claimed in claim 1, wherein (C) is at least one selected from a group consisting of a mercapto-based silane coupling agent and a sulfide-based silane coupling agent.

6. The vibration-damping rubber composition as claimed in claim 2, wherein (C) is at least one selected from a group consisting of a mercapto-based silane coupling agent and a sulfide-based silane coupling agent.

7. The vibration-damping rubber composition as claimed in claim 3, wherein (C) is at least one selected from a group consisting of a mercapto-based silane coupling agent and a sulfide-based silane coupling agent.

8. A vibration-damping rubber member, consisting of a vulcanized body of the vibration-damping rubber composition as claimed in claim 1.
